(19) United States
(12) Patent Application Publication
(10) Pub. No.: US 2002/0078818 A1
(43) Pub. Date: Jun. 27, 2002

(54) NETWORK- SUPPLIED SELECTABLE SOUND- DATA FOR TIME IDENTIFICATION

(76) Inventor: Brig Barnum Elliott, Arlington, MA (US)

Correspondence Address: Leonard C. Suchyta, Verizon Services Group, 600 Hidden Ridge HQE03G13, Irving, TX, 75038, US

(21) Appl. No.: 09/748,047

(22) Filed: Dec. 22, 2000

(51) Int. Cl. G10H 5/00

(52) U.S. Cl. 84/609; 84/610; 84/649; 84/650

(57) ABSTRACT

The disclosure describes a device that plays sound data transmitted over a network based on a specified time. For example, the device can act as an alarm clock that plays a sound file received over the network. The disclosure also describes a server for transmitting sound data to the device. The server can communicate with the device over a public network such as the Internet or over a local network such as a home network.

### REFERENCE TO RELATED APPLICATIONS

This application relates to U.S. patent application Ser. No. ______, entitled “STREAMING CONTENT”, filed Dec. 22, 2000.

### BACKGROUND OF THE INVENTION

1. Field of the Invention

The invention relates to playing sound data received over a network.

2. Description of Related Art

Devices which generate a sound at a specified time have become prevalent in modern society. Such devices serve to notify of upcoming deadlines and appointments, to rouse the sleeping, or merely to contribute to the aural environment.

A common example of such devices is an alarm clock. Alarm clocks often provide a set of pre-programmed electronic sounds such as buzzers, beeps, and chimes as alarm options. The set of electronic sounds is typically limited to a handful of different choices.

Many alarm clocks also include a radio receiver. Such clocks enable a user to select a particular radio station as an alarm. The alarm played by such clocks is dictated by the broadcast of the selected station at the alarm time. Thus, a user has little control over the sounds they will actually hear at alarm time.

Alarm clocks have also incorporated CD (compact disk) players. Such clocks enable users to select a track of an inserted CD for play at a specified time. While such devices provide a user with control over the sounds played by the alarm clock, the alarm options are nevertheless limited by the number of CDs accessible by an owner.

Devices other than alarm clocks also play sound data. For example, some devices play a bird call every hour on the hour.

The development of networks, such as the Internet, permit transmission of sound data from remote devices. The inventor of the present invention realized that combining aspects of the two existing technologies, that of sound generating time devices, and that of communication networks, may allow the delivery of a vast choice of sound data based on a specified time.

### SUMMARY OF THE INVENTION

The disclosure describes a device for playing sound data transmitted over a network based on a specified time. Such a device can have access to an enormous selection of sound data. For example, a clock can play sound data on the hour selected from libraries of sound data remotely stored on a network. Such sound data can include “fresh” content such as news, sports, and weather. The sound data can also include messages specifically created for the device owner, for example, by relatives or co-workers.

The disclosure also describes a server for transmitting sound data to the device. The server can communicate with the device over a public network such as the Internet or over a local network such as a home network.

In general, in one aspect, the invention features a method of producing sounds at a specified time. The method includes receiving a message over a network from a server that includes sound data and playing the sound data included in the received message based on the specified time.

Embodiments may include one or more of the following features. The received message may include identification of the specified time. The method may further include waiting until the specified time to play the sound data included in the message. The method may further include powering down at least one electronic component after playing the sound data. The method may further include receiving the specified time and transmitting a request for the sound data to the server based on the specified time. The method may further include storing the specified time at the server and transmitting the message including the sound data based on the stored specified time.

Receiving the message may include receiving the message at a device having a network connector, processor, time display, and speaker. The device is dedicated to tasks associated with displaying an indication of time on the time display and playing the sound data received via the network connector on the speaker. The network may be a public network such as the Internet, a home network, and so forth.

In general, in another aspect, the invention features a clock for playing sound at a specified time. The clock includes a time display, a speaker, a network connector, and a processor. The processor is configured to execute instructions for receiving sound data over the network connector and for playing the sound data on the speaker. The clock is dedicated to tasks associated with displaying a time indication on the time display and playing the received sound data on the speaker.

Embodiments may include one or more of the following features. The instructions for receiving sound data over the network connector can include instructions corresponding to at least one network protocol. The clock may further include electronics configured to power down the processor after the processor executes instructions for playing the sound data on the speaker. The network connector may include a wireless connector. The clock may further include user input controls. The instructions for playing the sound data can include instructions for playing the sound data based on the specified time.

In general, in another aspect, the invention features a network device for playing sound at a specified time. The device includes a speaker, a network connector, and a processor. The processor is configured to execute instructions for receiving sound data over the network connector and for playing the sound data on the speaker. The device is dedicated to tasks associated with playing the received sound data on the speaker.

In general, in another aspect, the invention features a computer program product, disposed on a computer readable medium, for use by a server in transmitting sound data over a network. The computer program includes instructions for causing a server processor to receive a specified time for playing sound data at a clock having a network connector and, based on the received time, transmitting a message over the network to the clock, the message including sound data for play by the clock.

Embodiments may include one or more of the following features. The program may include instructions for causing the processor to receive the specified time for playing the sound data over the network. The program may further include instructions for receiving the sound data for inclusion in the message over the network. The message may further include identification of the specified time. The instructions for causing the processor to transmit the message can include instructions for causing the processor to transmit the message over a home network and/or over a public network.

In general, in another aspect, the invention features a system for playing sounds. The system includes a local network that connects different local network devices; a server having access to the local network, the server storing sound data; and a clock having access to the local network, the clock being dedicated to tasks associated with displaying a time indication on a display and playing sound data received from the server over the local network on a speaker.

In general, in another aspect, the invention features a computer program product, disposed on a computer readable medium, for producing sounds at a specified time. The computer program includes instructions for causing a processor to receive the specified time transmitted over a network, receive sound data transmitted over a network, and, in accordance with the specified time, play the received sound data.

The above can offer a variety of advantages. For example, a classic music lover could have a play list of several hundred classical motifs that a clock could play at random. Similarly, a grandmother could have a play list of recordings of grandchildrens' voices and hear a selection from this list every hour. Additionally, the grandchildren could contribute new recordings of their voices from distant locations. Other potential advantages will become apparent in view of the following description, including the figures and the claims.

### BRIEF DESCRIPTION OF THE DRAWINGS

FIG. 1 is a diagram of a system including a server that transmits sound data to a device over a network.

FIG. 2 is a diagram of a device that plays sound data received over a network.

FIG. 3 is a diagram of a server that transmits sound data to a device over a network.

FIG. 4 is a screenshot of a user interface that receives information specifying times and sound data to play.

FIGS. 5-7 are flow-charts of processes for transmitting sound data from a server to a device.

FIG. 8 is a diagram of a system including a home network.

FIG. 9 is a diagram of a computer.

### DETAILED DESCRIPTION OF THE PREFERRED EMBODIMENT(S)

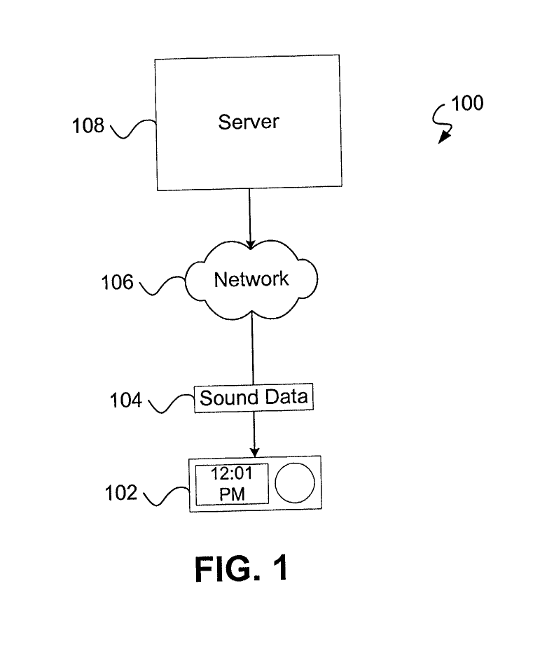

FIG. 1 shows a system 100 that transmits sound data 104 from a server 108 to a device 102 over a network 106 such as the Internet. The device 102 plays the sound data 104 based on a specified time. For example, a user may request a 7:00 AM wakeup alarm of local weather. Based on this request, at or prior to 7:00 AM, the server 108 transmits sound data 104 corresponding to the local weather to the device 102 for play.

Server 108, and other networked servers, can select sound data for transmission to the clock from an enormous library of sound data including music, sound effects, and so forth. As described above, the library can also include “fresh” content such as sound data corresponding to news, sports, and weather reports. In addition, others may submit sound data for a user to hear such as sound data corresponding to a voice mail message, a list of things to do, and so forth. The selection of sound data transmitted by server 108 may be based on user preferences and/or requests for transmission of particular sound data. Thus, system 100 shown, not only provides a user with a virtually unlimited source of sound data, but also enables a user to closely control the sounds played by clock 102.

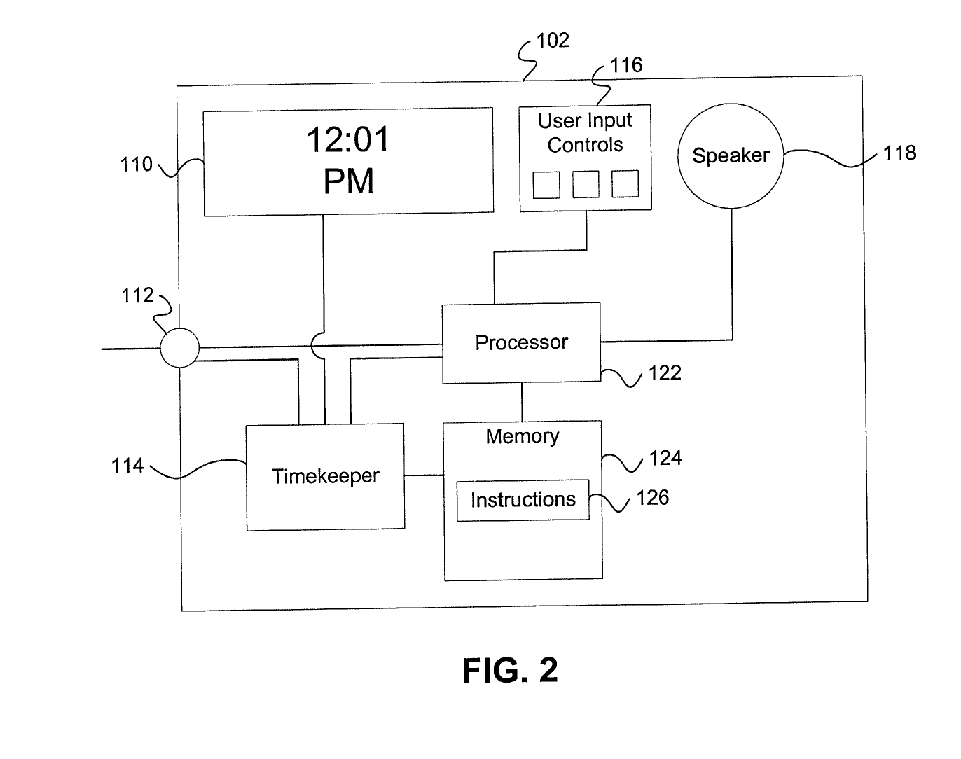

FIG. 2 shows an example of a device 102 for playing sound data received over a network based on a specified time. As shown, the device 102 includes a processor 122 that accesses memory 124 to execute instructions 126 for playing sound data received over a network connector 112 on a speaker 118. The instructions 126 can be configured to handle sound data encoded in different formats such as “.wav” files, RealAudio™ files, and so forth. The instructions 126 can also include implementations of one or more network protocols for handling communication over network connector 112. For example, the instructions 126 may support HTTP (HyperText Transfer Protocol), FTP (File Transport Protocol), TCP/IP (Transmission Control Protocol/Internet Protocol), UDP (User Datagram Protocol), and/or other protocols.

Device 102 shown also includes user input controls 116 that enable a user to configure the device 102. Such user input controls 116 can include buttons typically found on alarm clocks that enable a user to set the current time, set an alarm time, snooze, volume controls, and so forth. In lieu of, or in addition to, user input controls 116, device 102 may include a port (not shown) for receiving configuration settings from a wireless device such as a remote control or palmtop computer. The instructions 126 may also permit remote configuration of the device 102 via information sent to the device via network connector 112.

As shown, device 102 includes a time display 110 such as an analog or digital display. Processor 122 may control time display 110 to present the current time. Alternatively, “timekeeper” electronics 114 may track the current time and control the display 110 accordingly. Timekeeper electronics 114 may also keep track of pending alarms. By dividing tasks between timekeeper electronics 114 and processor 122, device 102 can reduce power demands by powering down processor 122 and other components when possible. For example, timekeeper electronics 114 can power-up processor 122 and other device 102 components when device 102 should play sound data and power-down processor 122 and other components when processor 122 finishes playing.

Device 102 shown is dedicated to tasks associated with displaying an indication of time on time display 110 and playing sound data received via network connector 112 on speaker 118. Such tasks can include tracking the current time, tracking upcoming alarms, receiving input configuring the device 102 to play sound at a specified time, handling network communication, receiving user input controlling sound output, and so forth. In other embodiments, however, the device 102 does not include a time display 110 and is dedicated to tasks associated with playing sound data received via network connector 112 on speaker 118 based on a specified time.

Device 102 may include other components that are not shown in FIG. 2 such as a power supply, digital-to-analog converter, and so forth. Device 102 may be included in a housing sized and shaped as a traditional clock radio. The device 102 may also be included in different products such as a video cassette recorder, a stereo system, a microwave oven, a dishwasher, a telephone, a telephone caller identification device, a telephone answering machine, an oven clock, and so forth.

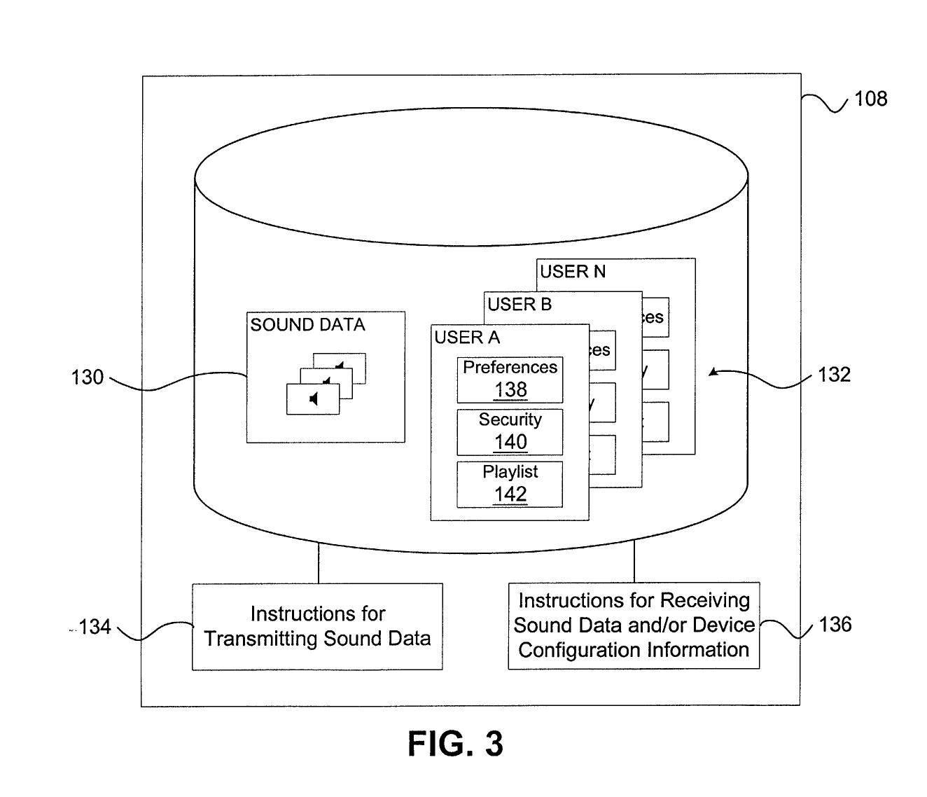

FIG. 3 illustrates a server 108 for transmitting sound data to a device 102 over a network. Though FIG. 3 shows only a single server 108, server 108 may actually form a collection of computers. Additionally, more than one server 108 may transmit sound data to device 102. For example, a server at www.cnn.com may transmit sound data associated with national news while a server at www.espn.com may transmit sound data of sports news.

As described above, server 108 can store a wide variety of sound data 130 for transmission to a device. As shown, server 108 may also store, or otherwise access, user information 132 about different users. Such information can include user preferences 138 that identify parameters of sound data the user would like to receive. For example, user preferences 138 can indicate the user prefers news in the morning and classical music in the afternoon. Server 108 may also store a history (not shown) of sound data transmitted to a user's device, for example, to prevent duplicate transmission of a particular piece of sound data. User information 132 may also include a play list 142. Play list 142 can identify different sound data files and the time such files should be transmitted to a device for play.

In addition to instructions for transmitting sound data 134 to a networked device 102 for play, server 108 may also include instructions for receiving sound data and/or device configuration information 136, such as web-server instructions, that enable submission of sound data for delivery to a device 102. For example, server 108 can receive sound data of a child's violin performance or a voice mail message for subsequent transmission to a user's device 102. Instructions 136 may also receive information specifying the time sound data should be transmitted.

To preserve user control over their device, user information 132 accessed by server 108 may include security information 140 identifying a password that must be entered to successfully submit sound or configuration data. Alternatively, the security information 140 may identify different authorized users or use other known techniques for restricting access.

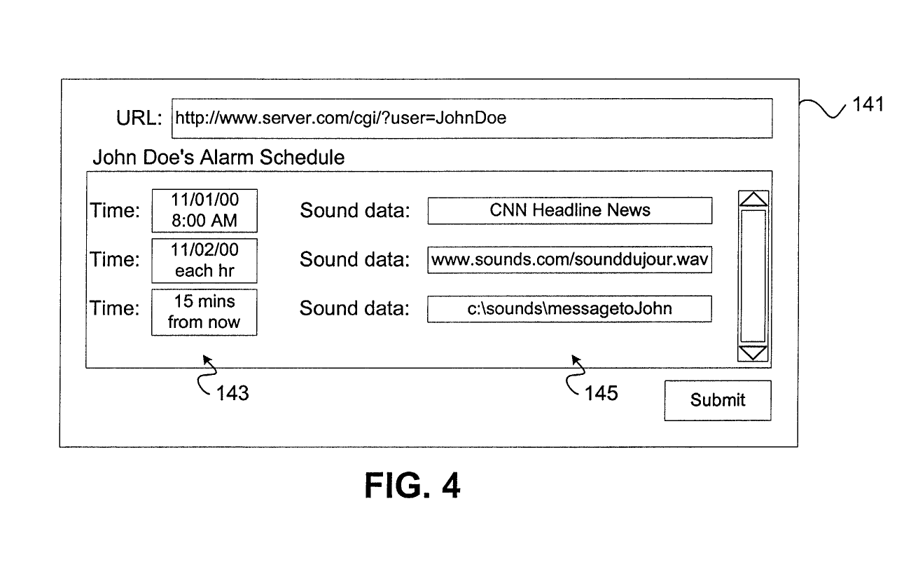

FIG. 4 illustrates a sample screenshot of a user interface 141 that can configure the server or device to play sound data based on a specified time 143. User interface 141 may be encoded as markup language instructions such as HTML (HyperText Markup Language) or another SGML (Structured Generalize Markup Language) instruction set. User interface 141 may be provided by a server 108 or device 102 via a browser such as Microsoft™ Internet Explorer, for example, to a device owner or an authorized third party.

As shown, interface 141 enables a remote user to specify time 143 for playing a sound file. As shown, time 143 may be an absolute time or a delta time that indicates an offset from the present (e.g., 15 minutes from now). Additionally, a single entry may specify multiple times, for example, by identifying a time interval between repeated plays.

As shown, interface 141 also enables a user to specify sound data 145 the server 108 will transmit to the device 102. Sound data 145 may be identified by a title. Alternatively, sound data 145 may be identified by its location, for example, by a URI (Universal Resource Indicator) or identification of a file for upload to the server 108 from the user's local directory.

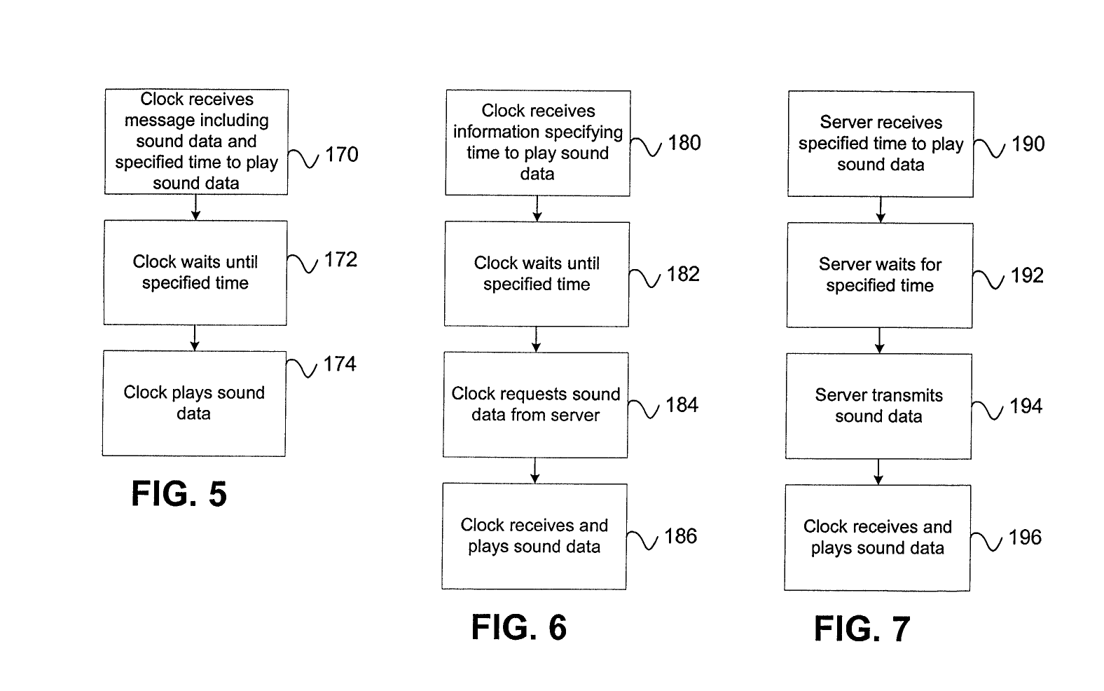

FIGS. 5-7 illustrate a subset of ways the device can play sound data based on a specified time. As shown in FIG. 5, in some embodiments, the device 102 can receive (step 170) a message from the server 108 that identifies a specified time and sound data to play at the specified time. After waiting (step 172) until the specified time, the device can play (step 174) the received sound data.

FIG. 6 shows another exemplary method for practicing an embodiment of the invention. As shown in FIG. 6, the device initially receives (step 180) information specifying a time to play sound data. After waiting (step 182) until the specified time, the device requests (step 184) sound data from the server 108. The device then plays (step 186) the sound data received from the server 108. To compensate for potential delays in data transmission, the device may request the sound data prior to the specified time, then wait until the specified time to play the received sound data.

FIG. 7 illustrates yet another exemplary method. In the method of FIG. 7, the server 108 receives (step 190) information specifying a time to play sound data at the device 102. This information may also include specification or submission of the sound data the device 102 will play. After waiting (step 192) until the specified time, the server 108 transmits (step 194) sound data to the device 102 for device 102 to play (step 196). Again, to compensate for potential delays in network transmission, the server 108 may begin transmitting the sound data well before the specified time.

As one of skill in the art will appreciate, a wide variety of variations and permutations of the above are possible. Additionally, device 102 and server 108 may authenticate one another. Further, in the different schemes 108 the server and/or device 102 may require a network address of the other to initiate network communication. Such a network address may be manually configured or determined in response to a query.

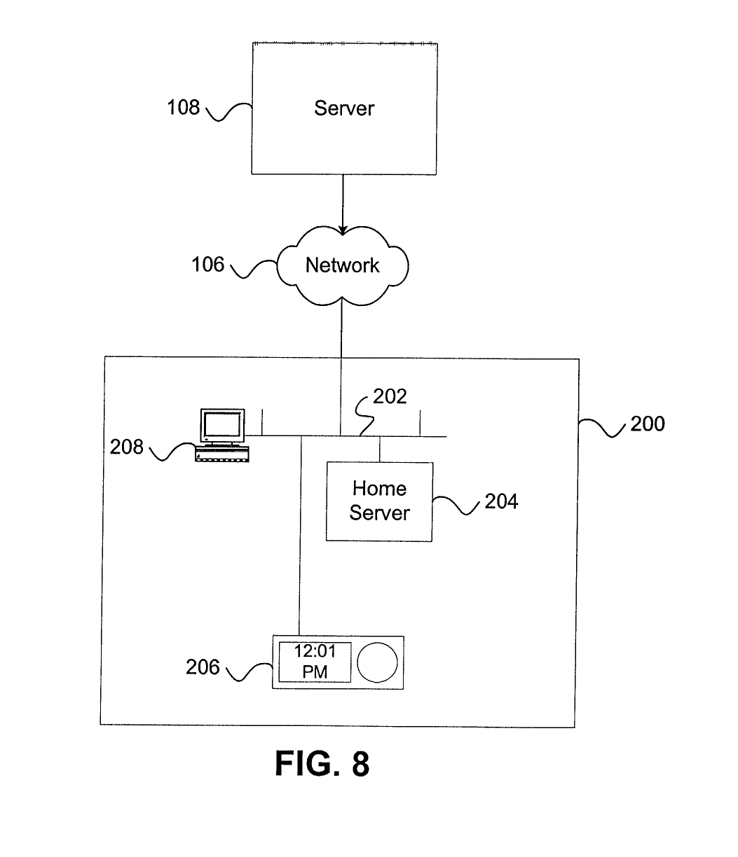

FIG. 8 illustrates another embodiment of a system for playing sound data received over a network 202 at a specified time. In FIG. 8, instead of a public network 106 such as the Internet, the device 206 and a home server 204 both attach to the same home network 202. Home network 202 and home server 204 can provide the same features as provided by the server 108 described in conjunction with FIG. 3.

Though shown as only serving a single device 206, home server 204 can transmit sound data to multiple devices 206 for play at a specified time. Thus, home server 204 can provide a “house-wide” alarm on different devices 206 located in different places within a residence 200.

Home network 202 can use a variety of techniques to interconnect residence 200 devices 206. For example, home network 202 can use wireless techniques such as RF (Radio Frequency) connections. Home network 202 can also transmit signals over residence electrical wiring. Additionally, local network 202 may use an unused wire pair of traditional residence telephone wiring. The network connector 112 featured by the device 206 may vary based on the home network connection(s) available.

Like server 108 of FIG. 3, the home server 204 may store sound data, a play list, user information, and so forth. Additionally, home server 204 may provide a user interface (see FIG. 4) for configuring the home server 204 and/or device 206. The user interface may be provided to a client 208 attached to home network 202 or a client (not shown) outside residence 200. Home server 204 may also receive information from other devices on home network 202. For example, a networked washing machine can schedule play of a song one-half hour after a washing cycle begins.

Home server 204 may request sound data from a server 108 on a public network 106. For example, if a user specifies sound data not currently stored by home server 204, home server 204 may request the sound data from public network 106 server 108. Additionally, public network 106 server 108 can transmit sound data submitted for delivery to a user to home server 204 for subsequent transmission to the user's device 206.

Home server 204 can also provide other features. For example, home server 204 can regularly (e.g., each minute) transmit a “heart-beat” message to the clock indicating the current time. This can synchronize each networked clock in a residence 200 to the same time.

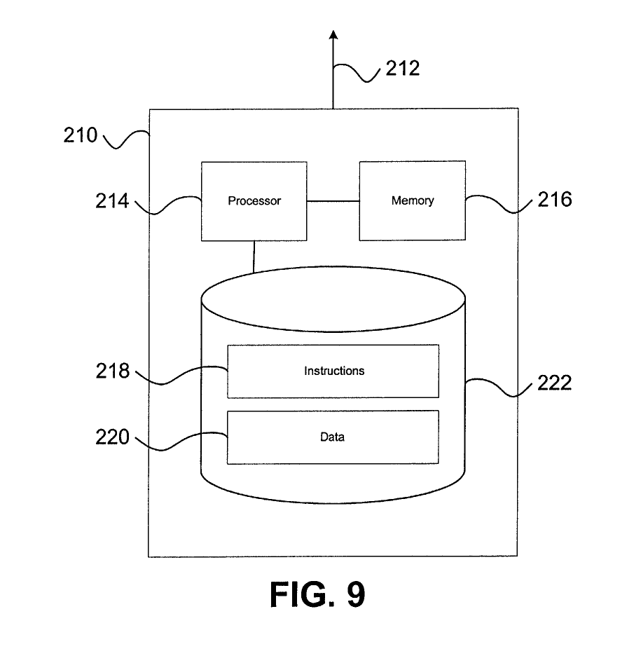

FIG. 9 shows a computer platform 210 suitable for use in providing a server 108, 204. As shown, platform 210 includes a network connector 212, volatile memory 216 and non-volatile memory 222, and at least one processor 214. Platform 210 accesses server instructions 218 and data 220 that implement techniques described above. Server instructions 218 may be transferred to volatile memory 216 for execution by processor 214 in the course of operation.

The techniques described herein may be implemented in hardware or software, or a combination of the two. Preferably, the instructions described herein are implemented in computer programs. Each program is preferably implemented in high level procedural or object oriented programming language to communicate with a computer system. However, the programs can be implemented in assembly or machine language, if desired. In any case the language may be compiled or interpreted language.

Other embodiments are within the scope of the following claims.

What is claimed is:

1. A method of producing sounds at a specified time, the method comprising:
receiving a message over a network from a server, the message including sound data; and
playing the sound data included in the received message based on the specified time.

2. The method of claim 1,
wherein the received message includes identification of the specified time; and
further comprising, waiting until the specified time to play the sound data included in the message.

3. The method of claim 1, further comprising powering down at least one electronic component after playing the sound data.

4. The method of claim 1, further comprising
receiving the specified time; and
transmitting a request for the sound data to the server based on the specified time.

5. The method of claim 1, further comprising
storing the specified time at the server; and
transmitting the message including the sound data based on the stored specified time.

6. The method of claim 1,
wherein receiving the message comprises receiving the message at a device having a network connector, processor, time display, and speaker, the device being dedicated to tasks associated with displaying an indication of time on the time display and playing the sound data received via the network connector on the speaker; and
wherein playing the sound data comprises executing instructions at the processor that output the sound data to the speaker.

7. The method of claim 1, wherein the network comprises the Internet.

8. The method of claim 1, wherein the network comprises a home network.

9. A clock having the ability to play sounds, the clock comprising:
a time display;
a speaker;
a network connector; and
a processor configured to execute instructions for receiving sound data over the network connector and for playing the sound data on the speaker;
the clock being dedicated to tasks associated with displaying a time indication on the time display and playing the received sound data on the speaker.

10. The clock of claim 9, wherein the instructions for receiving sound data over the network connector comprise instructions corresponding to at least one network protocol.

11. The clock of claim 9, further including electronics configured to power down the processor after the processor executes instructions for playing the sound data on the speaker.

12. The clock of claim 9, wherein the network connector comprises a wireless connector.

13. The clock of claim 9,
further comprising user input controls; and
wherein the processor comprises a processor configured to receive input from the user input controls.

14. The clock of claim 9, wherein the instructions for playing the sound data on the speaker comprise instructions for playing the sound data based on a specified time.

15. A network device for playing sound at a specified time, the device comprising:
a speaker;
a network connector; and
a processor configured to execute instructions for receiving sound data over the network connector and for playing the sound data on the speaker;
the device being dedicated to tasks associated with playing the received sound data on the speaker.

16. The device of claim 15, wherein the instructions for receiving sound data over the network connection comprise instructions corresponding to at least one network communication protocol.

17. The device of claim 15, wherein the instructions for playing the sound data on the speaker comprise instructions for playing the sound data based on a received time.

18. A computer program product, disposed on a computer readable medium, for use by a server in transmitting sound data over a network, the computer program including instructions for causing a server processor to:
receive a specified time for playing sound data at a clock having a network connector; and
based on the received time, transmitting a message over the network to the clock, the message comprising sound data for play by the clock.

19. The computer program of claim 18, further comprising instructions that cause the processor to receive the specified time for playing the sound data over the network.

20. The computer program of claim 18, further comprising instructions that cause the processor to receive the sound data for inclusion in the message over the network.

21. The computer program of claim 18, wherein the message further comprises identification of the specified time.

22. The computer program of claim 18, wherein the instructions for causing the processor to transmit the message comprise instructions for causing the processor to transmit the message over a home network.

23. The computer program of claim 18, wherein the instructions for causing the processor to transmit the sound data comprise instructions for causing the processor to transmit the sound data over a public network.

24. A system for playing sounds, the system comprising:
a local network that connects different local network devices;
a server having access to the local network, the server storing sound data; and
a clock having access to the local network, the clock being dedicated to tasks associated with displaying a time indication on a display and playing sound data received from the server over the local network on a speaker.

25. The system of claim 24, wherein the local network comprises a home network.

26. The system of claim 24, wherein playing sound data received from the server comprises playing the sound data based on a specified time.

27. The system of claim 26, wherein playing sound data based on the specified time comprises receiving the specified time at the clock and waiting until the specified time to play the sound data.

28. The system of claim 26, wherein playing sound data based on the specified time comprises receiving the specified time at the clock and transmitting a request for the sound data based on the specified time.

29. The system of claim 26, wherein the server comprises a server programmed to receive a specified time and transmit sound data to the clock based on the specified time.

30. The system of claim 26 wherein the server comprises a server having access to a public network.

31. The system of claim 30, wherein the server comprises a server configured to receive sound data over the public network for subsequent transmission to the clock over the local network.

32. A computer program product, disposed on a computer readable medium, for producing sounds at a specified time, the computer program including instructions for causing a processor to:
receive the specified time transmitted over a network;
receive sound data transmitted over a network; and
in accordance with the specified time, play the received sound data.

33. The computer program of claim 32, further comprising instructions for causing the processor to wait until the specified time to play the sound data included in the message.

34. The computer program of claim 32, further comprising instructions for causing the processor to transmit a request for the sound data based on the specified time.

35. The computer program of claim 32, wherein the network comprises a local network.

36. The computer program of claim 32, wherein the network comprises a public network.
